(19) United States
(12) Patent Application Publication
(10) Pub. No.: US 2008/0310664 A1
(43) Pub. Date: Dec. 18, 2008

(54) Piano Microphone Apparatus

(75) Inventors: Aleksey S. Khenkin, Peterborough, NH (US); Lawrence E. Blakely, Meridian, MS (US); William A. Simoneau, Hancock, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Earthworks, Inc., Milford, NH (US)

(21) Appl. No.: 12/138,746

(22) Filed: Jun. 13, 2008

Related U.S. Application Data
(60) Provisional application No. 60/943,915, filed on Jun. 14, 2007.

(51) Int. Cl. H04R 1/02

(52) U.S. Cl. 381/361

(57) ABSTRACT

A piano microphone apparatus configured to position at least one microphone within a sound cavity of a piano may comprise at least one piano interface configured to contact a case of a piano to suspend the microphone within the sound cavity of the piano. The piano microphone apparatus may also comprise at least one protruding member configured to receive a microphone and to adjustably position the microphone relative to at least one of the plurality of strings or soundboard. The length of the piano microphone apparatus may also be adjustable based on at least one dimension of the sound cavity.

### CROSS-REFERENCE TO RELATED APPLICATIONS

The present disclosure claims the benefit of U.S. Provisional Application Ser. No. 60/943,915 filed Jun. 14, 2007 and entitled PIANO MICROPHONE APPARATUS, which is fully incorporated herein by reference.

### FIELD

This disclosure relates generally to microphones and microphone stands. More specifically, this disclosure relates to a piano microphone apparatus configured to sit inside of a piano.

### BACKGROUND

Miking a piano can be a difficult task. In general, it is desirable for the microphone(s) to be directed at strings inside the piano. Some microphones may be mounted on external free-standing mic stands, then extended into the piano for miking. However, these stands may be visually unacceptable and may not allow the lid of the piano to close. Other microphones may be mounted on the edge of a piano with the lid opened, and are pointed inside. Here, again the piano lid may not able to close. Some pianos use miniature microphones mounted on suction cups inside the piano. The suction cups may be mounted to the piano frame, which may allow the lid to be opened and closed; however, the position of the microphones relative to the piano may result in poor recording. In some cases, the suction cups may be mounted directly to the inside surface of the lid for miking with the piano lid closed. While this may allow the microphone to be positioned at a desired location over the strings, the lid of the piano may not be opened without changing the position of the microphone. Further, the suction cups may become detached and fall onto the piano strings or inside the piano during a performance.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view illustrating a piano with a piano microphone apparatus in accordance with an exemplary embodiment of the present disclosure;

FIG. 2 is a top view illustrating a piano with a piano microphone apparatus in accordance with another exemplary embodiment of the present disclosure;

FIG. 3 is a perspective view illustrating a piano microphone apparatus in accordance with an exemplary embodiment of the present disclosure;

FIG. 4 is a perspective view illustrating a piano microphone apparatus in accordance with another exemplary embodiment of the present disclosure;

FIG. 5 is a perspective view illustrating a piano microphone apparatus in accordance with yet another exemplary embodiment of the present disclosure; and

FIG. 6 is a perspective view illustrating a piano microphone apparatus in accordance with a further exemplary embodiment of the present disclosure.

### DETAILED DESCRIPTION

Generally, this disclosure provides an apparatus configured to locate a microphone above the strings of a piano while being configured to allow the lid of the piano to open and close. The apparatus described herein may be suspended over the piano strings at an optimum recording position.

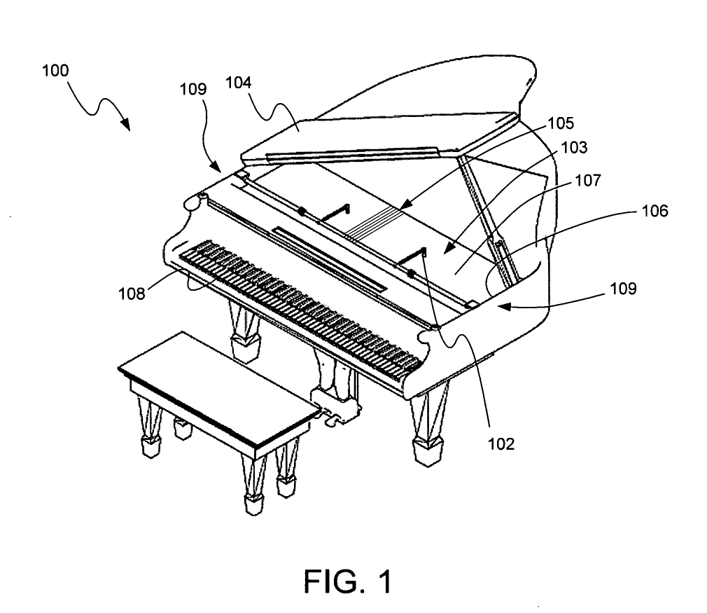

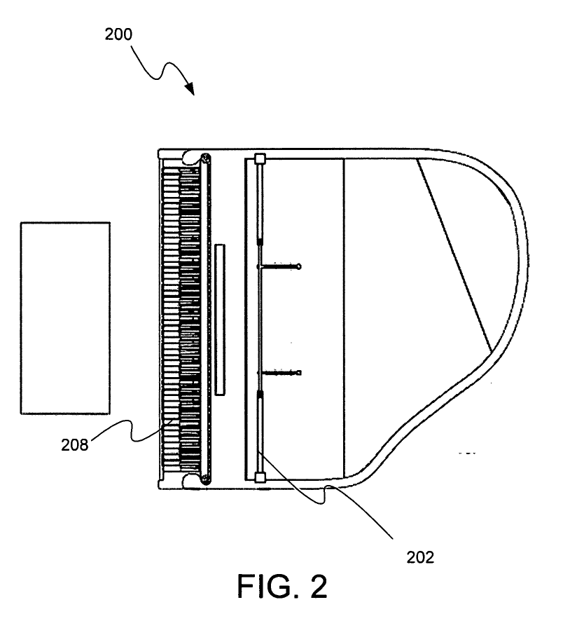

Referring now to FIGS. 1 and 2, an exemplary embodiment of a piano 100 having a piano microphone apparatus 102 located therein is shown. Apparatus 102 may be configured to fit within the piano while allowing the piano lid 104 to open and close and without interfering the microphone placement or the hammers in the piano. For example, the apparatus 102 may be configured to fit within a sound cavity 103 within the piano 100. The sound cavity 103 may comprise at least a portion of the strings 105, frame 106, and/or the soundboard 107 and may be defined by the lid 104 and the case 109. In some embodiments, apparatus 102 may be adjustable, allowing movement closer to, or further away from piano keys 108. Apparatus 102 may also be adjustable to permit the microphone head to be moved higher, lower and/or laterally with respect to the piano strings 105 and/or the soundboard 107. Apparatus 102 may be used in conjunction with a variety of different instruments, including but not limited to, spinet, console, studio, upright, petite grand, baby grand, medium grand, parlor grand, semiconcert, ballroom and concert grand pianos. Of course, the embodiments described herein may be equally applied to other musical instruments.

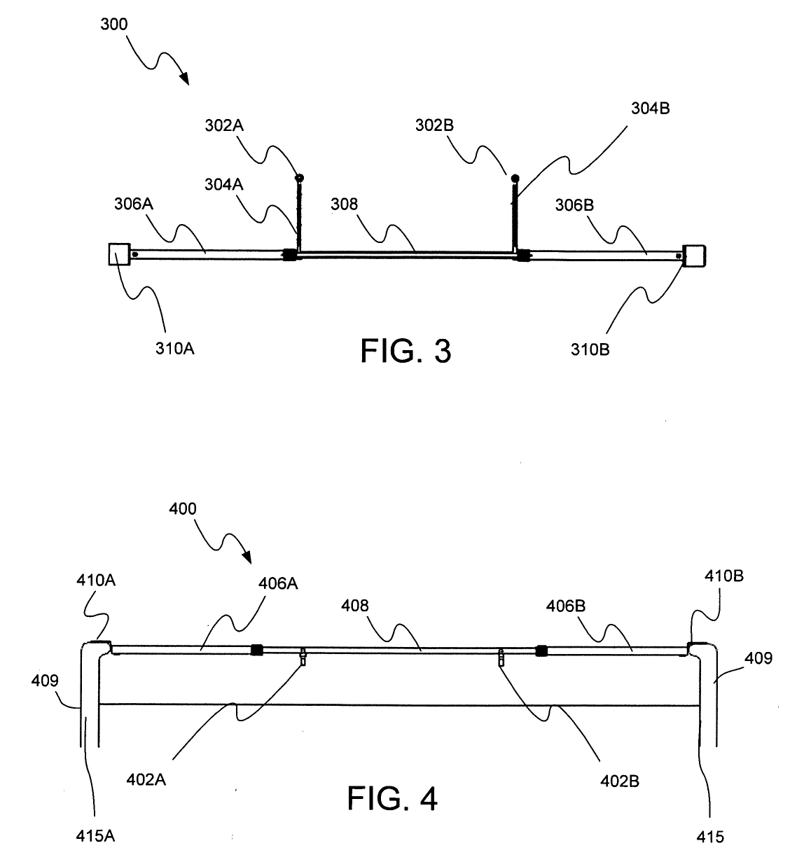

Referring now to FIG. 3 another exemplary embodiment of a piano microphone apparatus 300 is shown. Apparatus 300 may include at least one microphone, such as microphones 302A and 302B shown in FIG. 3. Microphones 302A and 302B may each be connected to protruding members 304A and 304B, respectively. Apparatus 300 may further include outer members 306A and 306B, which may be configured to operate in conjunction with inner member 308. In some embodiments, at least one of outer member 306A and/or 306B may be slidably operable with inner member 308 to permit, for example, the apparatus to adjust to the inside width of a particular piano. Each of outer members 306A and 306B may be connected with a piano interface such as interface 310A and 310B.

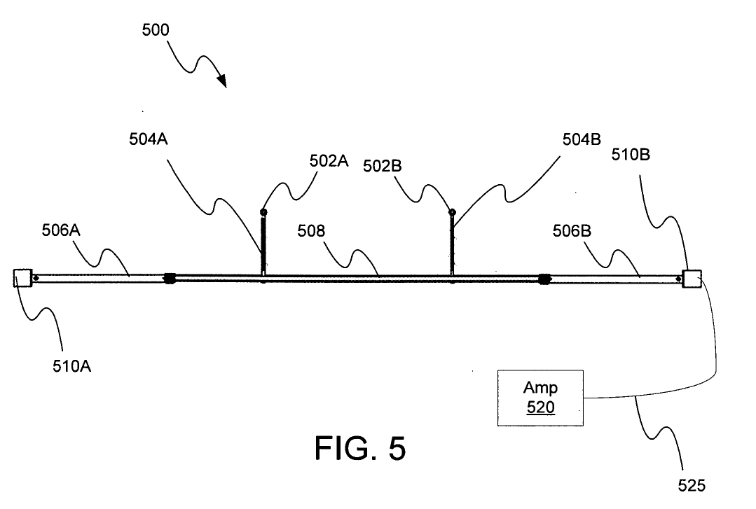

In some embodiments, microphones 302A and 302B may be affixed and/or removably attached to protruding members 304A and 304B. Although two microphones are depicted in the Figures, the embodiments described herein may be extended for use with any number of microphones. Protruding members 304A and 304B may be flexible in construction and may be configured to bend, allowing microphones 302A and 302B to be adjustably positioned in a specific location within the inside of the piano. Protruding members 304A and 304B may be configured to include a wire (reference numeral 525 as shown in FIG. 5) to provide power and/or signal to microphones 302A and 302B. For example, protruding members 304A, 304B may be hollow in construction, thus allowing the wire to pass therethrough. Protruding members 304A, 304B may be operatively connected with outer members 306A, 306B and/or inner member 308. In some embodiments, protruding members 304A, 304B may be adjustably positionable about the outer and/or inner members. In some embodiments, a track may be included that allows the protruding members to slide along either the outer and/or inner members. Once positioned, protruding members may be secured into place using a securing mechanism, including, but not limited to, clamps, screws, etc. Protruding members 304A, 304B may also be configured to rotate around either of the outer 306 and/or inner members 308.

Protruding members 304A, 304B may be affixed to inner member 308. Inner member 308 may act as a conduit for the wire and may be configured to deliver the wire to each of the protruding members 304A, 304B. Inner member 308 may also act as a housing for circuitry connected to microphones 302A and 302B and/or other electronic equipment outside the piano microphone apparatus. Inner member 308 may be operatively connected with outer members 306A, 306B using a variety of different arrangements. For example, inner member 308 may be connected with each of the outer members using a number of different arrangements, including but not limited to, screw-clamps, threaded rod, and/or any other suitable arrangement. Each of outer members 306A, 306B may be extended either towards or away from piano interfaces 310A, 310B. Once the correct position has been established outer members 306A, 306B and inner member 308 may be secured in place. In some embodiments, outer members 306A, 306B may be configured to move (e.g., slide) over the outside of, or inside of inner member 308, for example, in a telescoping arrangement. The adjustments provided by the inner and outer members allow apparatus 300 to fit pianos of varying sizes and widths.

Referring now to FIG. 4, another exemplary embodiment of a piano microphone apparatus 400 is shown. In some embodiments, outer members 406A, 406B may connect inner member 408 with piano interfaces 410A, 410B. At least a portion of each of piano interfaces 410A, 410B may be configured to rest on the sides 415A, 415B of the case 409 of a piano as shown in FIG. 4. In some embodiments, piano interfaces 410A, 410B may be thin enough to allow the lid of the piano to open and close without disturbing microphone apparatus 400 but strong enough to hold the apparatus in position. In some embodiments, piano interface 410A, 410B may include fixed or rotating brackets, flanges, L-shaped members, or any other mechanism capable of holding piano microphone apparatus 400 within the piano. In some embodiments, each piano interface 410A, 410B may be configured to rest in a substantially flush position with a side of the piano. Also, piano interfaces 410A, 410B may be secured to the piano using a variety of different techniques, including, but not limited to, screws, nails, rivets, etc. Each piano interface may be constructed out of a variety of different materials, including, but not limited to, metals and polymeric materials. In some embodiments, piano interfaces 410A, 410B may further include other securing mechanisms such as rubber or cloth, which may act to minimize movement of the apparatus 400 while minimizing any damage to the piano. Of course, various other arrangements are envisioned without departing from the scope of this disclosure.

Referring now to FIG. 5, another exemplary embodiment of a piano microphone apparatus 500 is shown. In some embodiments, each microphone 502A, 502B may be connected to an amplifier 520 and/or a recording device (not shown) or other audio equipment using a wire 525. Wire 525 may extend from amplifier 520, through the inner 506 and outer 508 members, into protruding members 504 and eventually to microphones 502. In some embodiments, microphones 502A and 502B may be wireless and may include a built-in transmitter configured to communicate with a receiver or other device. In other embodiments, microphones 502A and/or 502B may be dynamic or ribbon-type devices which would not need amplification or microphone electronics.

The microphones 502A, 502B may include commercially available microphones suitable for use with pianos, such as the types available from Earthworks Audio, Inc. in Milford, N.H. Such microphones may also include dynamic, ribbon-type, condenser, optical, wireless or other types of microphone devices as may be known in the art. The microphones 502A, 502B may also be specially tuned for the location inside the piano.

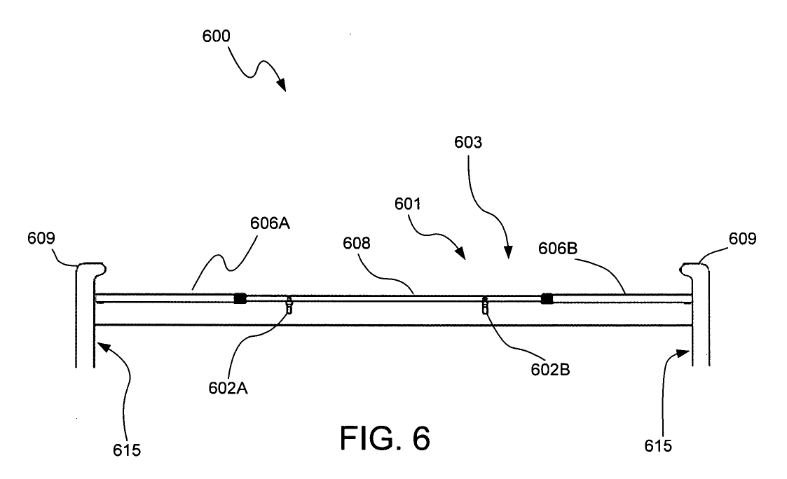

Turning now to FIG. 6, another exemplary embodiment of a piano microphone apparatus 600 is shown. The piano microphone apparatus 600 may comprise a support 601, for example, a telescopic support. In some embodiments, the support 601 may comprise one or more outer members 606A, 606B which may be coupled to one or more inner members 608. The support 601 may be configured to exert a force against the inside 615 of the case 609 sufficient to support the piano microphone apparatus 600 within the sound cavity 603 of the piano. For example, the support 601 may comprise a biasing device (such as, but not limited to, a spring or the like) configured to bias the support 601 outwardly along the longitudinal axis of the support 601. The support 601 may also comprise a threaded arrangement in which the length of at least two portions of the support 601 (for example, but not limited to, one or more of the outer and/or inner members 606, 608) may be extended and/or retracted along the longitudinal axis of the support 601. Other embodiments for providing a biasing force to support the piano microphone apparatus 600 within the sound cavity 603 of the piano are possible for example, but not limited to, a securing mechanism (e.g., a clamp or the like) configured to adjust the length of the support 601 to provide the biasing force. In such an embodiment, the piano microphone apparatus 600 may not need the interfaces described above.

In some embodiments, portions of the piano microphone apparatus may be constructed out a variety of different materials. Some of these materials may include, but are not limited to, metals, polymeric materials, ceramic materials, etc. Of course, other materials are also within the scope of this disclosure.

Accordingly, the present disclosure may feature an apparatus comprising a first and at least a second piano interface configured to contact a case of a piano and allow a lid of the piano to close. At least one support may extend between the first and at least the second piano interface within a sound cavity of the piano and at least one protruding member may be coupled to the support. The protruding member may be configured to receive a microphone and to position the microphone within the sound cavity of the piano.

The present disclosure may also feature a system comprising a piano and a microphone apparatus. The piano may comprise a case, a lid, a sound cavity, and a plurality of strings and soundboard at least partially disposed within the sound cavity. The microphone apparatus may comprise a first and at least a second piano interface configured to contact the case and allow the lid to close. At least one support may extend between the first and at least the second piano interface within the sound cavity and at least one protruding member may be coupled to the support. The protruding member may be configured to receive a microphone and to position the microphone within the sound cavity.

The present disclosure may also feature a method of miking a piano. The method may comprise adjusting a length of a microphone apparatus based on at least one dimension of a sound cavity of the piano, supporting the microphone apparatus within the sound cavity on a case of the piano to allow a lid of the piano to close, and positioning at least one microphone secured to the microphone apparatus within the sound cavity.

It should be emphasized that the above-described embodiments of the present disclosure are merely possible examples of implementations, merely set forth for a clear understanding of the principles of the disclosure. Other systems, methods, features, and advantages of the present disclosure will be or become apparent to one with skill in the art upon examination of the drawings and detailed description. It is intended that all such additional systems, methods, features, and advantages be included within this description, be within the scope of the present disclosure, and be protected by the accompanying claims.

What is claimed is:

1. An apparatus comprising:
a first and at least a second piano interface configured to contact a case of a piano and allow a lid of said piano to close;
at least one support extending between said first and at least said second piano interface within a sound cavity of said piano; and
at least one protruding member coupled to said at least one support, said at least one protruding member configured to receive a microphone and to position said microphone within said sound cavity of said piano.

2. The apparatus of claim 1, wherein said at least one support comprises a plurality of adjustable members configured to move with respect to each other and to adjust a length of said at least one support.

3. The apparatus of claim 2, wherein said at least one support comprises at least one inner member and at least one outer member, said inner and outer members configured to move with respect to each other and to adjust a length of said at least one support.

4. The apparatus of claim 3, wherein said at least one protruding member is coupled to said inner member or said outer member.

5. The apparatus of claim 4, wherein said at least one protruding member is flexible.

6. The apparatus of claim 5, wherein said at least one protruding member is configured to adjustably position said at least one microphone proximate the strings of said piano.

7. The apparatus of claim 5, wherein said at least one protruding member and at least one of said at least one inner member or said at least one outer member are configured to receive a wire configured to connect said at least one microphone with an amplifier.

8. The apparatus of claim 5, wherein said at least one protruding member is configured to rotate around at least one of said inner or said outer members.

9. The apparatus of claim 3, wherein said at least one outer member is configured to move relative to said at least one inner member.

10. The apparatus of claim 1, wherein at least one of said first and at least said second piano interface comprises an L-shaped member.

11. A system comprising:
a piano, said piano comprising a case, a lid, a sound cavity, and a plurality of strings and soundboard at least partially disposed within said sound cavity; and
a microphone apparatus, said microphone apparatus comprising:
a first and at least a second piano interface configured to contact said case and allow said lid to close;
at least one support extending between said first and at least said second piano interface within said sound cavity; and
at least one protruding member coupled to said at least one support, said at least one protruding member configured to receive a microphone and to position said microphone within said sound cavity.

12. The system of claim 11, wherein said at least one support comprises a plurality of adjustable members configured to move with respect to each other and to adjust a length of said at least one support.

13. The system of claim 12, wherein said at least one support comprises at least one inner member and at least one outer member, said inner and outer members configured to move with respect to each other and to adjust a length of said at least one support.

14. The system of claim 13, wherein said at least one protruding member is coupled to said inner member or said outer member.

15. The system of claim 14, wherein said at least one protruding member is flexible.

16. The system of claim 15, wherein said at least one protruding member and at least one of said at least one inner member or said at least one outer member are configured to receive a wire configured to connect said at least one microphone with an amplifier.

17. The system of claim 15, wherein said at least one protruding member is configured to rotate around at least one of said inner or said outer members.

18. The system of claim 13, wherein said at least one outer member is configured to move relative to said at least one inner member.

19. The system of claim 12, wherein at least one of said first and at least said second piano interface comprises an L-shaped member.

20. A method of miking a piano comprising:
adjusting a length of a microphone apparatus based on at least one dimension of a sound cavity of said piano;
supporting said microphone apparatus within said sound cavity on a case of said piano to allow a lid of said piano to close; and
positioning at least one microphone secured to said microphone apparatus within said sound cavity.
